(19) United States
(12) Patent Application Publication
(10) Pub. No.: US 2013/0242106 A1
(43) Pub. Date: Sep. 19, 2013

(54) MULTICAMERA FOR CROWDSOURCED VIDEO SERVICES WITH AUGMENTED REALITY GUIDING SYSTEM

(71) Applicants: Jussi Leppänen, Tampere (FI); Antti Eronen, Tampere (FI)

(72) Inventors: Jussi Leppänen, Tampere (FI); Antti Eronen, Tampere (FI)

(73) Assignee: Nokia Corporation, Espoo (FI)

(21) Appl. No.: 13/422,428

(22) Filed: Mar. 16, 2012

(51) Int. Cl. H04N 7/18

(52) U.S. Cl. 348/159; 348/E07.085

(57) ABSTRACT

An apparatus comprising at least one processor and at least one memory including computer program code may be configured to determine at least one desired media content to be captured. The apparatus may be configured to cause information regarding a request to be transmitted to at least two media capturing devices to capture media content at distinct positions. The apparatus may be configured to receive information regarding the captured media content captured by the media capturing devices. Corresponding methods and computer program products are also provided.

### TECHNOLOGICAL FIELD

An example embodiment of the present invention relates generally to media recording and more particularly, to an augmented reality guidance system configured to direct users to positions for capturing media with a media capturing device.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Further, mobile terminals now include capabilities to capture media content, such as photographs, video recordings and/or audio recordings. As such, users may now have the ability to record media whenever users have access to an appropriately configured mobile terminal. Accordingly, multiple users may attend an event with each user using a different mobile terminal to capture various media content of the event activities. The captured media content may include redundant content. In addition, some users may capture media content of particular unique portions of the event activity such that each user has a unique perspective and/or view of the event activity. Thereby, the entire library of captured content by multiple users may be compiled to provide a composite media content comprising multiple content media captured by different users of the particular event activity to provide a more fulsome media content of an event. However, efforts to mix media content, such as video recordings, captured by a number of different users of the same event have proven to be challenging, particularly in instances in which the users who are capturing the video recordings are unconstrained in regards to their relative position to the performers and in regards to the performers who are in the field of view of the video recordings.

### BRIEF SUMMARY

A method, apparatus and computer program product therefore provide for an augmented reality system for providing for composite media content having multi-camera zooming and/or panning portions. In a first example embodiment, an apparatus is provided that includes at least one processor and at least one memory including computer program code with the at least one memory and the computer program code configured to, with the processor, cause the apparatus to determine at least one desired media content to be captured. In addition, the at least one memory and the computer program code are configured to, with the processor, cause the apparatus to cause information regarding a request to be transmitted to at least two media capturing devices to capture media content at distinct positions. Further, the at least one memory and the computer program code are configured to, with the processor, cause the apparatus to receive information regarding the captured media content captured by the media capturing devices.

In another example embodiment, a method may include determining, via a processor, at least one desired media content to be captured. In addition, the method may comprise causing information regarding a request to be transmitted to at least two media capturing devices to capture media content at distinct positions. In one embodiment, the method may also include receiving information regarding the captured media content captured by the media capturing devices.

In another example embodiment, a computer program product is provided. The computer program product of the example embodiment may include at least one non-transitory computer-readable storage medium having computer-readable program instructions stored therein. The computer-readable program instructions may comprise program instructions configured to cause an apparatus to perform a method comprising determining at least one desired media content to be captured. In addition, the program instructions may also be configured to cause information regarding a request to be transmitted to at least two media capturing devices to capture media content at distinct positions. In one embodiment, the program instructions may also be configured to receive information regarding the captured media content captured by the media capturing devices.

In a further embodiment, an apparatus is provided that includes means for determining at least one desired media content to be captured. In addition, the apparatus may include means for causing information regarding a request to be transmitted to at least two media capturing devices to capture media content at distinct positions. In one embodiment, the apparatus may also include means for receiving information regarding the captured media content captured by the media capturing devices.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1 illustrates a schematic representation of a plurality of mobile terminals capturing media content at an event activity according to an example embodiment of the present invention;

FIG. 2 illustrates a schematic block diagram of a mobile terminal according to an example embodiment of the present invention;

FIG. 3 illustrates a schematic block diagram of an apparatus that may be configured to capture user generated media content and to receive instructions for capturing requested media content according to an example embodiment of the present invention;

FIG. 4a illustrates a schematic representation of an event attended by a plurality of users having media capturing devices that illustrates the initial positions of the users;

FIG. 4b illustrates a schematic representation of an event attended by a plurality of users that illustrates locations to which the users are directed according to an example embodiment of the present invention;

FIG. 4c illustrates a schematic representation of an event attended by a plurality of users that illustrates the respective fields of view of the media capturing devices of the users after having been repositioned according to an example embodiment of the present invention;

FIG. 4d illustrates a schematic representation of an event attended by a plurality of users that illustrates the initial positions of the users and the respective field of view of the media capturing devices of the users according to an example embodiment of the present invention;

FIG. 4e illustrates a schematic representation of an event attended by a plurality of users that illustrates the respective fields of view of the media capturing devices of the users after having been repositioned according to an example embodiment of the present invention;

FIG. 4f illustrates a schematic representation of an event attended by a plurality of users that illustrates the initial positions of the users and the respective field of view of the media capturing devices of the users according to an example embodiment of the present invention;

FIG. 4g illustrates a schematic representation of an event attended by a plurality of users that illustrates the respective fields of view of the media capturing devices of the users after having been repositioned according to an example embodiment of the present invention;

FIG. 5a illustrates the view from the perspective of a first user of an apparatus according to an example embodiment of the present invention;

FIG. 5b illustrates the view from the perspective of a second user of an apparatus according to an example embodiment of the present invention;

FIG. 5c illustrates the view from the perspective of a third user of an apparatus according to an example embodiment of the present invention;

FIG. 6a illustrates an apparatus configured to display instructions to a user attending an event according to one embodiment of the present invention;

FIG. 6b illustrates an apparatus configured to display instructions to a user attending an event according to another embodiment of the present invention;

FIG. 7 is a flow chart illustrating operations performed by an apparatus that may include or otherwise be associated with a mobile terminal in accordance with an example embodiment of the present invention; and

FIG. 8 illustrates a schematic representation of a composite media content in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

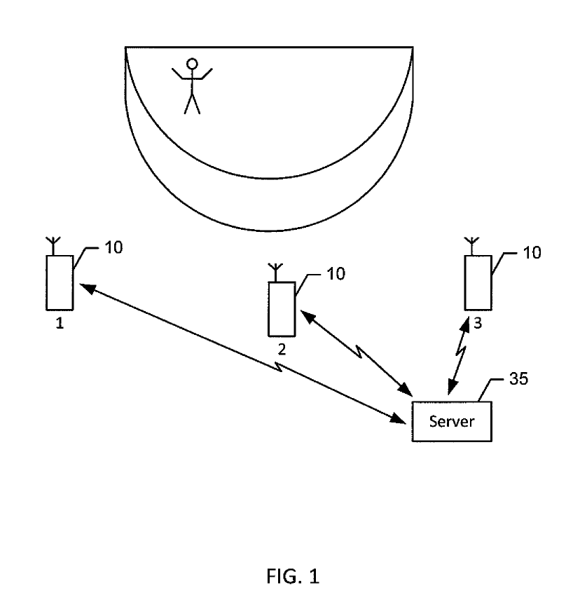

As indicated above, some embodiments of the present invention may be employed in methods, apparatuses and computer program products configured to provide instructions and/or guidance for capturing media content and compile user-generated media content to provide a composite media content having at least one of a multi-camera zoom portion and a multi-camera panning portion. In this regard, FIG. 1 illustrates a concert where a performer is on stage. The concert of FIG. 1 is only for purposes of example and the method, apparatus and computer program product may also be utilized in conjunction with a number of different types of events including sporting events, plays, musicals, or other types of performances. Regardless of the type of event, a plurality of people may attend the event. As shown in FIG. 1, a number of people who attend the event may each have user equipment, such as the mobile terminal 10, that may include a media capturing module, such as a video camera, for capturing media content, such as video recordings, image recordings, audio recordings and/or the like. With respect to the example depicted in FIG. 1, three mobile terminals designated as 1, 2 and 3 may be carried by three different attendees with each mobile terminal configured to capture media content, such as a video recording of at least a portion of the event. While the user equipment of the illustrated embodiment may be mobile terminals, the user equipment need not be mobile and, indeed, other types of user equipment may be used.

Based upon the relative location and orientation of each mobile terminal 10, the field of view of the media capturing module of each mobile terminal may include aspects of the same event. Alternatively, the field of view of the media capturing module of each mobile terminal may include no similar aspects of the same event. As shown in FIG. 1, the mobile terminals 10 or other types of user equipment may provide the captured media content to a server 35 or other media content processing device that is configured to store the user-generated media content and, in some instances to combine the recorded media content by the various media capturing modules, such as by mixing the video recordings captured by video cameras of the mobile terminals. As shown in FIG. 1, the server 35 or other media content processing device that collects the recorded media content captured by the media capturing modules may be a separate element, distinct from the user equipment. Alternatively, one or more of the user equipment may perform the functionality associated with the collection and processing, e.g., mixing or otherwise forming a combination of the recorded videos captured by the plurality of the media capturing modules. However, for the purposes of example, but not of limitation, a server or other media content processing device that is distinct from the user equipment including the media capturing modules will be described below.

As shown in FIG. 1, the plurality of mobile terminals 10 or other user equipment may communicate with the server 35 or other media content processing device so as to provide information regarding the recorded videos and/or related information, e.g., context information, in a variety of different manners including via wired or wireless communication links. Indeed, while the example of embodiment illustrates direct communications links between user equipment and the server or other media content processing device, the system of another embodiment may include a network for supporting wired and/or wireless communications therebetween.

In some embodiments the mobile terminals 10 may be capable of communicating with other devices, such as other user terminals, either directly, or via a network. The network may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network. Although not necessary, in some embodiments, the network may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network. By directly or indirectly connecting the mobile terminals 10 and the other devices to the network, the mobile terminals and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the mobile terminals 10 and the other devices may be enabled to communicate with the network and/or each other by any of numerous different access mechanisms. For example, mobile access mechanisms such as universal mobile telecommunications system (UMTS), wideband code division multiple access (W-CDMA), CDMA2000, time division-synchronous CDMA (TD-CDMA), global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network may be a home network or other network providing local connectivity.

The mobile terminals 10 may be configured to capture media content, such as pictures, video and/or audio recordings. As such, the system may additionally comprise at least one composite media server 35 which may be configured to receive any number of user-generated media content from the mobile terminals 10, either directly or via the network. In some embodiments, the composite media server 35 may be embodied as a single server, server bank, or other computer or other computing devices or node configured to transmit and/or receive composite media content and/or user-generated media content by any number of mobile terminals. As such, for example, the composite media server may include other functions or associations with other services such that the composite media content and/or user-generated media content stored on the composite media server may be provided to other devices, other than the mobile terminal which originally captured the media content. Thus, the composite media server may provide public access to composite media content received from any number of mobile terminals. Although illustrated in FIG. 1 as a single server, in some embodiments the composite media server 35 comprises a plurality of servers.

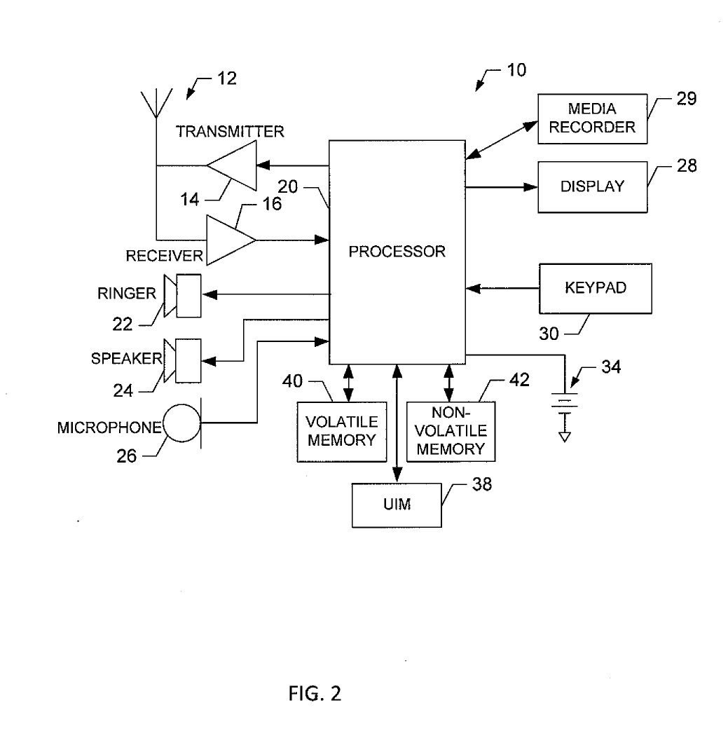

FIG. 2 illustrates a block diagram of a mobile terminal 10 that would benefit from embodiments of the present invention. Indeed, the mobile terminal 10 may serve as the mobile terminal in the embodiment of FIG. 1 so as to capture media content and transmit such content to a composite media server. It should be understood, however, that the mobile terminal 10 as illustrated and hereinafter described is merely illustrative of one type of device that may serve as the mobile terminal and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

As illustrated in FIG. 2, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include media content data, user generated data, user requested data, and/or the like. In this regard, the mobile user terminal may be capable of operating with one or more air interface standards, communication protocols, modulation types, access types, and/or the like. Some Narrow-band Advanced Mobile Phone System (NAMPS), as well as Total Access Communication System (TACS), mobile user terminals may also benefit from embodiments of this invention, as should dual or higher mode phones (e.g., digital/analog or time division multiple access (TDMA)/code division multiple access (CDMA)/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, the media recorder 29, the keypad 30 and/or the like. In addition, the processor 20 may further comprise user interface circuitry configured to control at least some functions of one or more elements of the user interface, such as a media recorder 29 configured to capture media content. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile user terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display. The user input interface may comprise devices allowing the mobile user terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile user terminal.

The mobile terminal 10 may comprise memory, such as a user identity module (UIM) 38, a removable user identity module (R-UIM), and/or the like, which may store information elements related to a mobile subscriber. In addition to the UIM, the mobile user terminal may comprise other removable and/or fixed memory. The mobile terminal 10 may include non-transitory volatile memory 40 and/or non-transitory, non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile user terminal for performing functions of the mobile terminal. For example, the memories may comprise an identifier, such as an international mobile equipment identification (IMEI) code, capable of uniquely identifying the mobile terminal 10.

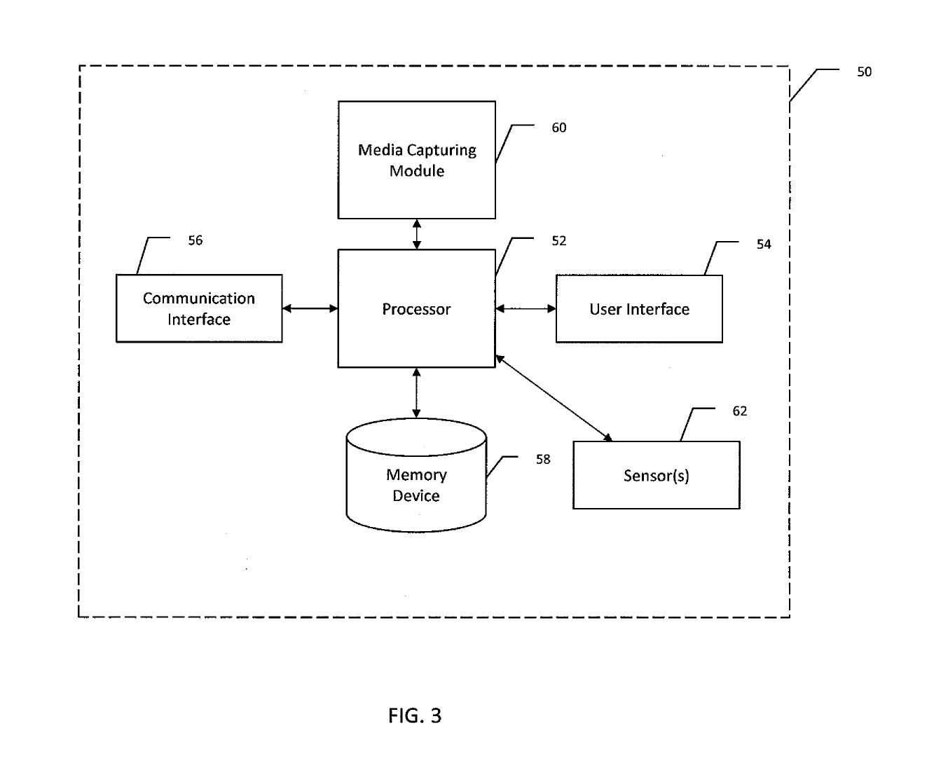

In an example embodiment, an apparatus 50 is provided that may be employed by devices performing example embodiments of the present invention. The apparatus 50 may be embodied, for example, as any device hosting, including, controlling, comprising, or otherwise forming a portion of the mobile terminal 10 and/or the composite media server 35. However, embodiments may also be embodied on a plurality of other devices such as for example where instances of the apparatus 50 may be embodied by a network entity. As such, the apparatus 50 of FIG. 3 is merely exemplary and may include more, or in some cases less, than the components shown in FIG. 3.

With further regard to FIG. 3, the apparatus 50 may include or otherwise be in communication with a processor 52, an optional user interface 54, a communication interface 56 and a non-transitory memory device 58. The memory device 58 may be configured to store information, data, files, applications, instructions and/or the like. For example, the memory device 58 could be configured to buffer input data for processing by the processor 52. Alternatively or additionally, the memory device 58 could be configured to store instructions for execution by the processor 52. In an instance in which the apparatus 50 is embodied by a mobile terminal 10, the apparatus 50 may also be configured to capture media content and, as such, may include a media capturing module 60, such as a camera, a video camera, a microphone, and/or any other device configured to capture media content, such as pictures, audio recordings, video recordings and/or the like.

As mentioned above, in some embodiments, the apparatus 50 may be embodied by a mobile terminal 10, the composite media server 35, or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 52 may be embodied in a number of different ways. For example, the processor 52 may be embodied as one or more of various hardware processing means such as a co-processor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. As such, in some embodiments, the processor 52 may include one or more processing cores configured to perform independently. A multi-core processor may enable multiprocessing within a single physical package. Additionally or alternatively, the processor 52 may include one or more processors configured in tandem via the bus to enable independent execution of instructions, pipelining and/or multithreading.

In an example embodiment, the processor 52 may be configured to execute instructions stored in the memory device 58 or otherwise accessible to the processor. The processor 52 may also be further configured to execute hard coded functionality. As such, whether configured by hardware or software methods, or by a combination thereof, the processor 52 may represent an entity (for example, physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor to perform the algorithms and/or operations described herein when the instructions are executed. However, in some cases, the processor 52 may be a processor of a specific device (for example, a user terminal, a network device such as a server, a mobile terminal, or other computing device) adapted for employing embodiments of the present invention by further configuration of the processor by instructions for performing the algorithms and/or operations described herein. The processor 52 may include, among other things, a clock, an arithmetic logic unit (ALU) and logic gates configured to support operation of the processor.

Meanwhile, the communication interface 54 may be any means such as a device or circuitry embodied in either hardware, software, or a combination of hardware and software that is configured to receive and/or transmit data from/to a network and/or any other device or module in communication with the apparatus 50. In this regard, the communication interface 54 may include, for example, an antenna (or multiple antennas) and supporting hardware and/or software for enabling communications with a wireless communication network. In fixed environments, the communication interface 54 may alternatively or also support wired communication. As such, the communication interface 54 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 54 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further be configured to transmit and/or receive media content, such as a picture, video and/or audio recording. In one embodiment, the communication interface 56 may be configured to transmit and/or receive a media content package comprising a plurality of data, such as a plurality of pictures, videos, audio recordings and/or any combination thereof. In this regard, the processor 52, in conjunction with the communication interface 56, may be configured to transmit and/or receive a composite media content package relating to media content captured at a particular event, location, and/or time. Accordingly, the processor 52 may cause the composite media content to be displayed upon a user interface 54, such as a display and/or a touchscreen display. Further still, the apparatus 50 may be configured to transmit and/or receive instructions regarding a request to capture media content from a particular location. As such, the apparatus 50 may be configured to display a map or other directional indicia on a user interface 54, such as a touchscreen display and/or the like. Although the apparatus 50 need not include a user interface 54, such as in instances in which the apparatus is embodied by a composite media server 35, the apparatus of other embodiments, such as those in which the apparatus is embodied by a mobile terminal 10, may include a user interface. In those embodiments, the user interface 54 may be in communication with the processor 52 to display media content being captured by the media capturing module 60. Further, the user interface 54 may be in communication with the processor 52 to display navigational indicia and/or instructions for capturing media content at a desired location. For example, the user interface 54 may include a display and/or the like configured to display a map with navigational indicia, such as a highlighted target position, configured to provide a user with instructions for traveling to a desired location to capture media content. The user interface 54 may also include, for example, a keyboard, a mouse, a joystick, a display, a touch screen, a microphone, a speaker, or other input/output mechanisms. Alternatively or additionally, the processor 52 may comprise user interface circuitry configured to control at least some functions of one or more elements of the user interface 54, such as, for example, the speaker, the ringer, the microphone, the display, and/or the like. The processor 52 and/or user interface circuitry comprising the processor 52 may be configured to control one or more functions of one or more elements of the user interface 54 through computer program instructions (e.g., software and/or firmware) stored on a memory accessible to the processor 52 (e.g., memory device 58, and/or the like). In another embodiment, the user interface 54 may be configured to record and/or capture media content as directed by a user. Accordingly, the apparatus 50, such as the processor 52 and/or the user interface 54, may be configured to capture media content with a camera, a video camera, and/or any other image data capturing device and/or the like.

In one embodiment, the media content that is captured may include a device-specific user identifier that provides a unique identifier as to when the media content was captured and by whom or what device captured the media content. In this regard, the apparatus 50 may include a processor 52, user interface 54, and/or media capturing module 60 configured to provide a user identifier associated with media content captured by the apparatus 50.

The apparatus 50 may also optionally include or otherwise be associated or in communication with one or more sensors 62 configured to capture context information. The sensors may include a global positioning system (GPS) sensor or another type of sensor for determining a position of the apparatus. The sensors may additionally or alternatively include an accelerometer, a gyroscope, a compass or other types of sensors configured to capture context information concurrent with the capture of the media content by the media capturing module 60. The sensor(s) may provide information regarding the context of the apparatus to the processor 52, as shown in FIG. 3.

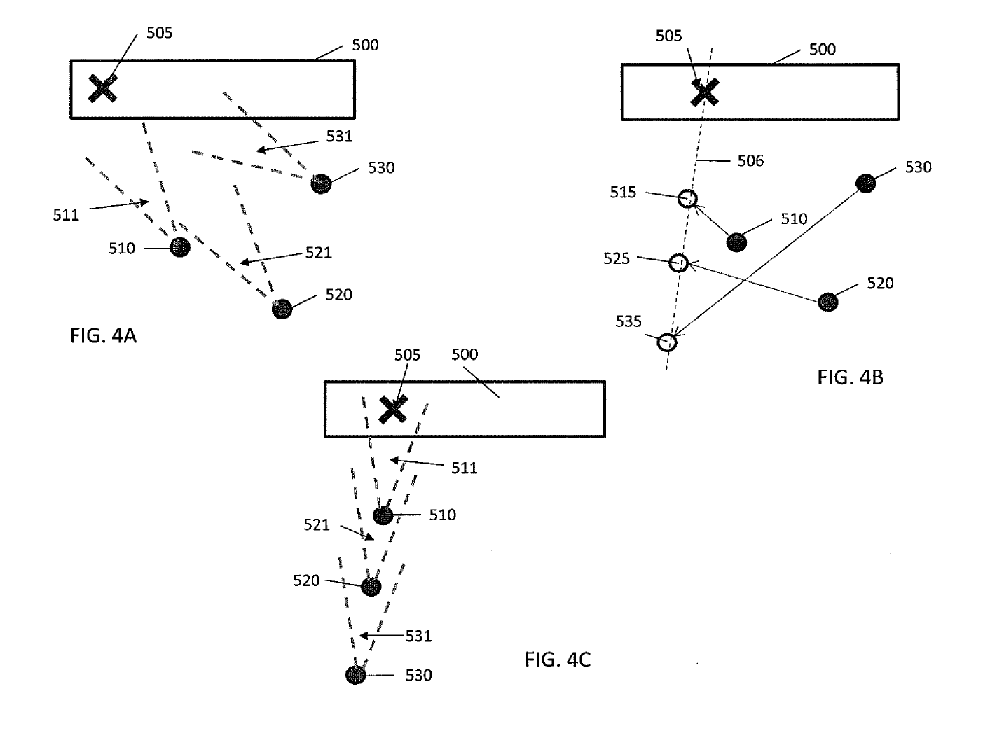

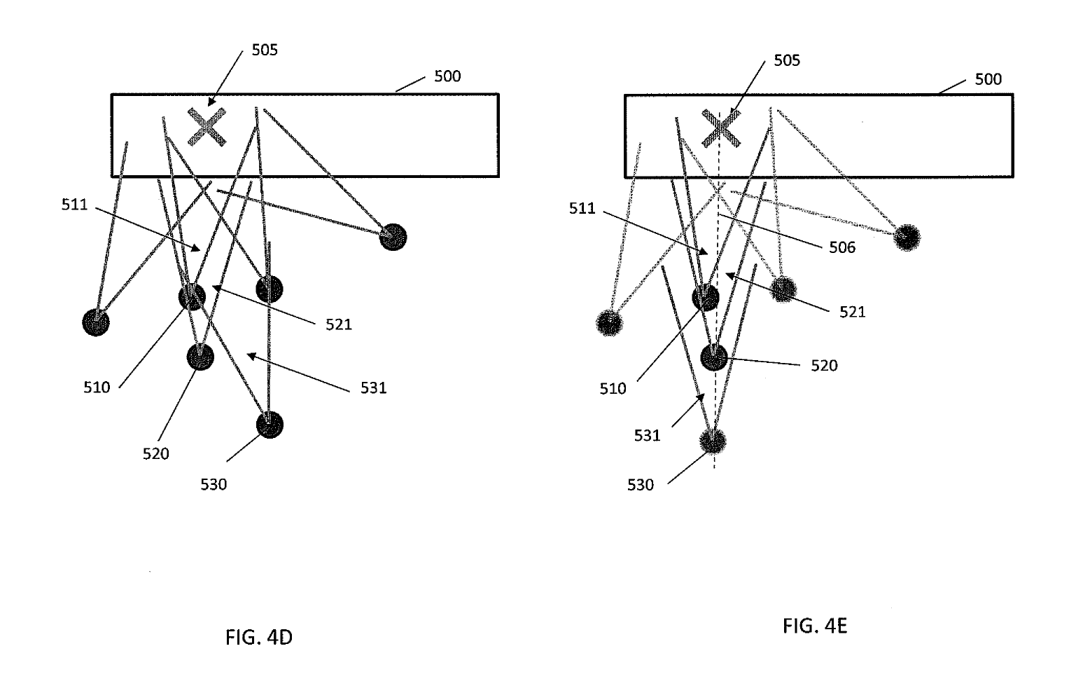

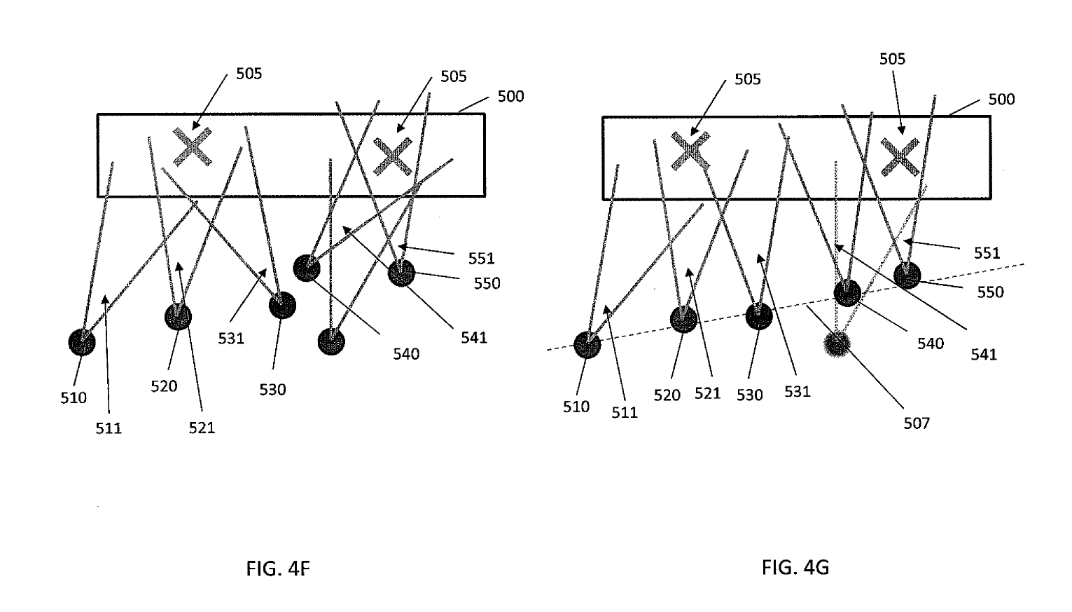

FIGS. 4a, 4b, 4c, 4d, 4e, 4f, and 4g illustrate a schematic representation of an event attended by a first user 510, a second user 520, and a third user 530. According to one embodiment of the present invention, the first user 510, second user 520 and third user 530 may be focusing on and/or capturing media content of a target area of interest 505 on a stage 500. Accordingly, the mobile terminal of the first user 510 may have a field of view 511, the mobile terminal of the second user 520 may have a field of view 521, and the mobile terminal of the third user 530 may have a field of view 531. In one embodiment of the present invention, a composite media server and/or a media content processing device may determine a need for a media content which may include a multi-camera zoom portion and/or a multi-camera panning portion. For example, in some embodiments, the first user mobile terminal 510, the second user mobile terminal 520 and the third user mobile terminal 530 may be configured to provide location data, such as data corresponding to each of the mobile terminals position and/or orientation. According to one embodiment, each of the mobile terminals may be configured to provide a composite media content server with location data corresponding to the location, orientation, direction of the field of view, and/or the like of the mobile terminal. According to some embodiments, each of the mobile terminals may be configured to provide a composite media content server with the location data separately from any media content captured by any of the mobile terminals. As such, the composite media content server may be configured to receive the location data from any one of the mobile terminals, and may be further configured to determine the mobile terminals are in a suitable position for capturing media content for a multi-camera zoom and/or panning portion. According to some embodiments, the mobile terminals may be located in positions proximate to an ideal position for a multi-camera zoom and/or panning portion.

In some embodiments, a composite media content server may be configured to determine a desired target area of interest suitable for a multi-camera zooming portion and/or a multi-camera panning portion. For example, a composite media content server may be configured to receive location data corresponding to the location, orientation, direction of the field of view, and/or the like of the mobile terminal. Accordingly, a composite media content server may be configured to determine a central axis bisecting the field of view of any one of the mobile terminals. In one embodiment, the composite media content server may be configured to determine the location and/or when the orientations and/or the field of views of the mobile terminals intersect, as shown in FIG. 4d. Accordingly, the composite media content server may be configured to determine that a target area of interest 505 is suitable for a multi-camera zooming portion. Accordingly, the composite media content server may be configured to transmit instructions to selected mobile terminals and request each of the user to a specific position for capturing media content. As such, the first user, second user, and third user 510, 520, 530 may position themselves along a zoom axis 506 for capturing media content for a composite media content containing a multi-camera zoom portion. Additionally and/or alternatively, the composite media content server may be configured to determine the location of where the central axis of each mobile terminal intersects.

In some embodiments, the composite media content server may be configured to determine that a desired target area of interest is suitable for a multi-camera zooming portion and/or a multi-camera panning portion based at least in part on the number of field of views of the mobile terminals that are focused on a particular area. In another embodiment, a number of target areas of interests may exist wherein a number of mobile terminals are focused on the plurality of target areas of interests, as shown in FIG. 4f. Accordingly, a composite media content server may be configured to determine that the plurality of target areas of interest may be suitable to a multi-camera panning portion. Accordingly, the composite media content server may be configured to transmit instructions to the mobile terminals of a first user, second user, third user, fourth user, and fifth user 510, 520, 530, 540, 550 to position themselves along a multi-camera panning axis 507 for capturing media content. Additionally and/or alternatively, the composite media content server may be configured to receive media content from each of the mobile terminals to create a composite media content including a multi-camera panning portion that includes media content of the plurality target areas of interest. In another embodiment, the composite media content server may be configured to receive media content from a plurality of mobile devices. According to one embodiment, the composite media content server may be configured to visually analyze media contents from a plurality of mobile terminals, each media content containing video recordings and/or image recordings, to determine if a similar target area of interest exists within any one of the media contents provided by any of the mobile terminals.

Additionally and/or alternatively, a composite media content server may be configured to determine a plurality of lines between mobile terminals, wherein each line includes a single pair of mobile terminals. Further, the composite media content server may be configured to determine if a desired target area of interest 505 is aligned with any one of the pair connecting lines, as shown in FIG. 4e. Accordingly, a composite media content server may be configured to determine that a particular line includes the desired target area of interest 505, a first mobile terminal 510 and a second mobile terminal 520. Additionally and/or alternatively, the composite media content server may be further configured to determine that a third mobile terminal is located proximate to the connecting line that includes the target area of interest, the first mobile terminal and the second mobile terminal. As such, the composite media content server may transmit a request to a user utilizing the third mobile terminal to move to a desired position that is located on the line including the target area of interest, the first mobile terminal and the second mobile terminal such that the first, second, and third mobile terminal may be positioned of provide media content to a composite media content server for composing a composite media content including a multi-camera zoom portion. In another embodiment, the composite media content server may be configured to determine a line including the positions of the first and second mobile terminals is positioned such that a multi-camera panning portion could be created with additional mobile terminals were located on the line including the first and second mobile terminals, wherein each of the mobile terminals were capturing media content of the same target of interest. Accordingly, the composite media content server may determine an appropriate zoom axis 506, wherein the target area of interest 505 resides along the zoom axis 506. As such, the composite media content server and/or media content processing device may determine appropriate positions for capturing the media content, such as a first position 515, a second position 525, and a third position 535. In one embodiment, for example, the first, second and third positions may all be along the zoom axis. In an instance in which multi-camera zooming is desired, the first, second and third positions may be at different distances from the target area. Additionally and/or alternatively, in an instance in which multi-camera panning is desired, the first, second and third positions may be proximate one another along a panning axis with each of the users focusing on the same target area from different locations on the panning axis. Although illustrated in FIG. 4b as having only three positions, one skilled in the art will appreciate that the composite media server and/or media content processing device may determine any number of appropriate positions for capturing the desired media content.

According to one example embodiment of the present invention, the composite media content server may be configured to transmit instructions and/or data regarding the appropriate first position 515, second position 525, and third position 535 to any one of the first, second, and/or third users 510, 520, 530. As shown in FIG. 4b, the first user 510 may receive instructions to travel to the first position 515, the second user 520 may receive instructions to travel to the second position 520, and the third user 530 may receive instructions to travel to the third position 530. As such, each of the users may travel to their respective positions, as illustrated in FIG. 4c, all of which are then aligned along the zoom axis 506. By being positioned at different distances from the target area, the images captured by the various users may support multi-camera zooming with the image captured by the first user being zoomed, e.g., having greater magnification, relative to the image captured by the second user and being even further zoomed relative to the image captured by the third user.

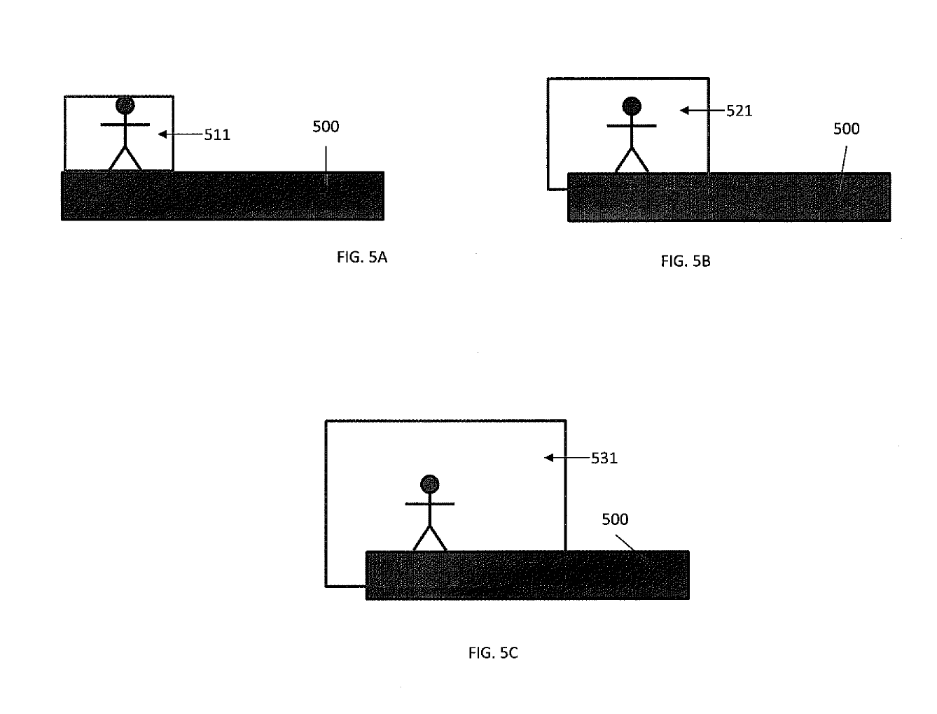

Once in the appropriate positions, each of the users may begin capturing media content of the targeted area of interest. FIG. 5a illustrates the first user's field of view 511 of the first user's media capturing module. FIG. 5b illustrates the second user's field of view 521 of the second user's media capturing module. FIG. 5c illustrates the third user's field of view 531 of the third user's media capturing module.

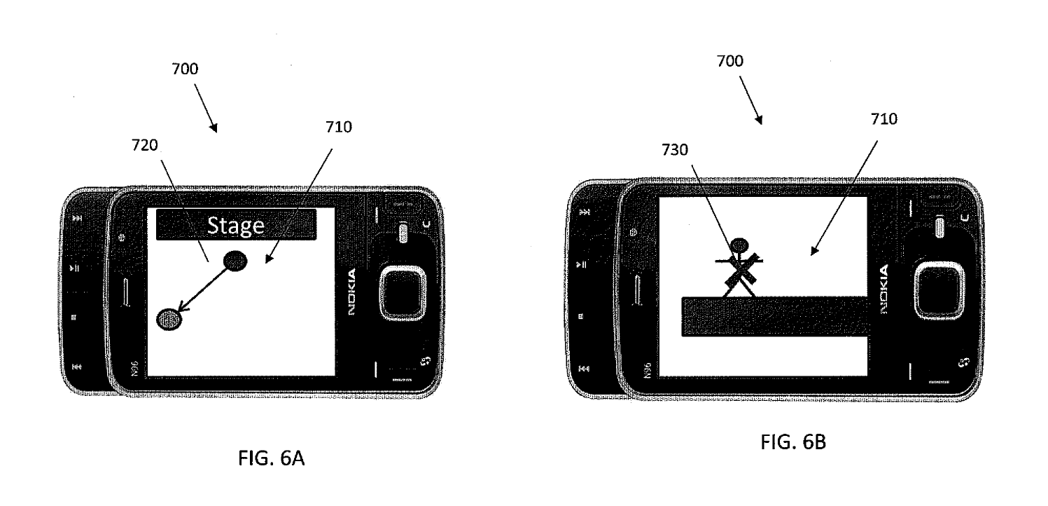

FIGS. 6a and 6b illustrate an apparatus 700 according to one embodiment of the present invention. The apparatus 700 may include a user interface 710, such as a touch screen display. The apparatus 700 may be configured to capture, display, and/or otherwise provide a media content via the user interface 710. According to one example embodiment of the present invention, a user may capture media content with the apparatus 700, and may further receive information and or data regarding a desired target location from which to capture media content. For example, the apparatus may be configured to receive instructions, such as a map 720 configured to be displayed by the user interface 710. In another example embodiment, the user interface 710 may be configured to display an augmented reality view of the media capturing module on the user interface 710. As shown in FIG. 6b, the apparatus 700 may be configured to display a target indicia 730 on the user interface 710, so as to direct a user to capture media content of a particular action, event, target, and/or the like.

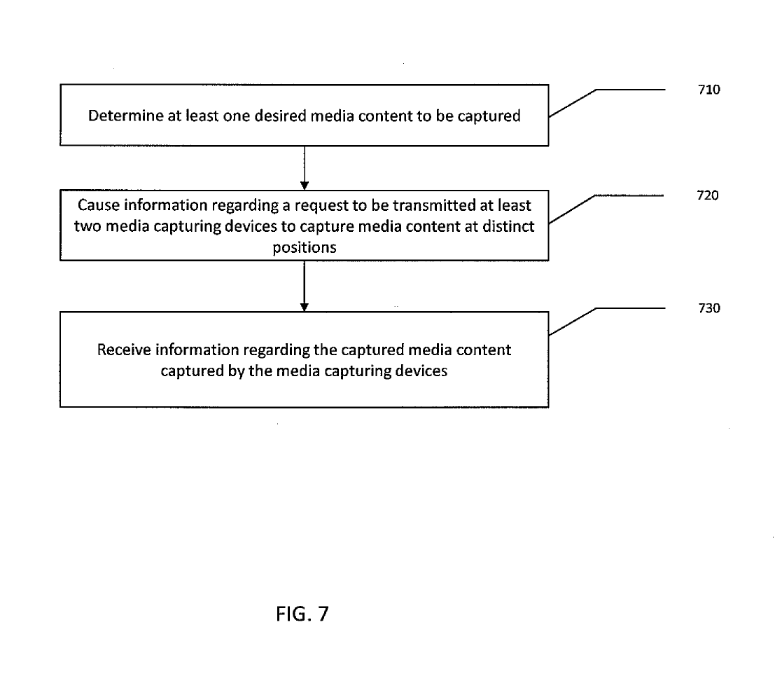

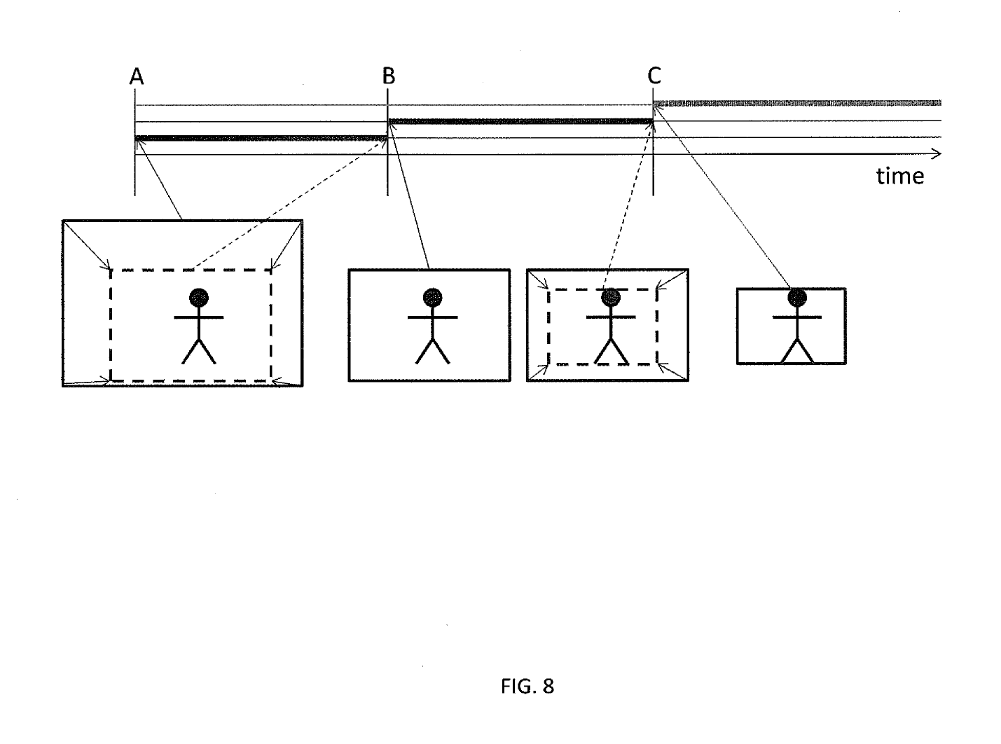

Referring now to FIG. 7, the operations performed by a method, apparatus, and computer program product of an example embodiment as embodied by the composite media server 35 or other media content processing device will be described. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

In this regard, the apparatus 70 embodied by the media content processing device may include means, such as the processor 72, the communications interface 76, and/or the memory device 78 for determining at least one desired media content to be captured. For example, the apparatus may be configured to receive positional data of a number of mobile terminals, wherein the positional data includes data corresponding to the position of the user, the direction of the field of view of the mobile terminal capturing media content, and/or the like. Accordingly, the processor 72 may be configured to determine that a number of mobile terminals are located at a particular event activity and that a number of mobile terminals may be positioned to capture media content so as to provide differing zoom level recorded contents and/or differing angle recorded contents to a media content processing device. For example, the apparatus 70 may determine that a composite media content comprising a plurality of user-generated media content combined to form a multi-camera zooming effect or a multi-camera panning effect is desired. See block 710. According to one example, the composite media content server may be configured to determine the desired positions of any number of users utilizing media capturing modules for capturing media content. Additionally and/or alternatively, the server may also determine the appropriate angles or directions a user should point the media capturing module to capture the media content. As described above, each media capturing module may be positioned at different distances from a target area along a zoom axis in order to support multi-camera zooming. Alternatively, each media capturing module may be directed to be focused upon and to capture different areas, such as target areas that are adjacent to, but offset from one another to support multi-camera panning between the different images captured by the media capturing modules.

The server may then cause information regarding a request to be transmitted to any number of media capturing devices to capture media content at respective and/or distinct positions. See block 720. For example, the server may be configured to communicate with each mobile terminal and provide respective mobile terminals with instructions comprising at least navigational and targeting information for capturing media content of a particular target of interest from a desired location. In one embodiment of the present invention, the composite media server may be configured to cause transmission to a mobile terminal augmented reality data, such as a map of the event location with a respective desired shooting location overlaid on the map. In another embodiment of the present invention, the composite media server may be configured to cause transmission to a mobile terminal augmented reality data, such as a targeting indicia overlaid on a user interface displaying the desired target of interest, such as a particular performer on stage. According to one embodiment of the present invention, augmented reality data including a targeting indicia may be provided to a mobile terminal only when the mobile terminal is in the correct position for shooting the media content.

The mobile terminal may include means, such as a processor, and one or more sensors or the like, for determining whether the mobile terminal is in the desired position for capturing media content. As noted above, the mobile terminal of one example embodiment may include one or more sensors including, for example, a GPS or other position determination sensor, a gyroscope, an accelerometer, a compass or the like. As such, the processor of the mobile terminal may be configured, with a communication interface, to receive and/or transmit contextual information captured by the one or more sensors, such as information relating to the position and/or orientation of the mobile terminal.

Once a mobile terminal has captured the appropriate media content, each of the mobile terminals may be configured to transmit the captured media content to a composite media server or other media content processing device. Accordingly, a composite media server may be configured to receive information regarding the captured media content captured by the mobile terminals and/or media capturing devices. See block 730. For example, the composite media server may be configured to communicate with each of the mobile terminals and receive the captured media content from any number of mobile terminals. In another embodiment of the present invention, the composite media content server may be configured to align the user-generated media content captured by each respective mobile terminal in a time-wise manner. Such alignment may be accomplished, for example, by cross-correlating audio tracks of the recorded media content. Further, once each of the user-generated media content are aligned with respect to one another along a single unified timeline, the composite media content server may be further configured to select portions of media content from any one of the captured media content so as to compose a composite media content containing portions of user-generated media content captured by the mobile terminals.

Accordingly, as illustrated in FIG. 8, the composite media content may include user-generated media content captured by respective users aligned along a unified timeline. For example, a first portion A of the composite media content may include portions of user-generated media content from a first user who was positioned furthest from the target of interest. The second portion B of the composite media content may include portions of user-generated media content from a second user who was positioned closer to the target of interest with respect to the first user. A third portion C of the composite media content may include portions of user-generated media content from a third user who was positioned closest to the target of interest. Accordingly, the composite media content server may be configured to provide a composite media content comprising portions of user-generated media content to support multi-camera zooming as a result of the different levels of magnification provided by the first, second and third portions of the composite media content. Although the example of FIG. 9 depicts first, second and third portions of the composite media content that all focus upon the same target area, but have different levels of magnification, the first, second and third portions of the composite media content of another embodiment may capture images (either of the same or different levels of magnification) of different target areas, such as adjacent but offset target areas, so as to support multi-camera panning In another embodiment, the composite media content may include first, second, and third portions of the composite media content that focus on the same target area, but were captured from different locations along a panning axis so as to support multi-camera panning.

Some advantages of embodiments of the present invention may include increased production of user-generated media content of an event activity having greater artistic value. In addition, additional advantages may include the increased distribution of composite media content, as greater number of users may wish to view more interesting media content, such as media content having zooming and/or panning portions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
determine at least one desired media content to be captured;
cause information regarding a request to be transmitted to at least two media capturing devices to capture media content at distinct positions; and
receive information regarding the captured media content captured by the media capturing devices.

2. The apparatus of claim 1, wherein the information regarding the request comprises augmented reality data.

3. The apparatus of claim 2, wherein the augmented reality data comprises an augmented reality map.

4. The apparatus of claim 2, wherein the augmented reality data comprises a targeting indicator configured to provide a user with an indication when the user has an appropriate view of a scene to be captured.

5. The apparatus of claim 1 further configured to:
align the captured media contents along a unified timeline; and
compile a composite media content comprising portions of the captured media contents.

6. The apparatus of claim 5 further configured to select portions of any one of the captured media contents so as to create a composite media content including at least one of a multi-camera zoom portion and a multi-camera panning portion.

7. A method comprising:
determining, via a processor, at least one desired media content to be captured;
causing information regarding a request to be transmitted to at least two media capturing devices to capture media content at distinct positions; and
receiving information regarding the captured media content captured by the media capturing devices.

8. The method of claim 7, wherein the information regarding the request comprises augmented reality data.

9. The method of claim 7, wherein the augmented reality data comprises an augmented reality map.

10. The method of claim 7, wherein the augmented reality data comprises a targeting indicator configured to provide a user with an indication when the user has an appropriate view of a scene to be captured.

11. The method of claim 7 further comprising:
aligning the captured media contents along a unified timeline; and
compiling a composite media content comprising portions of the captured media contents.

12. The method of claim 11 further comprising selecting portions of any one of the captured media contents so as to create a composite media content including at least one of a multi-camera zoom portion and a multi-camera panning portion.

13. A computer program product comprising at least one non-transitory computer-readable storage medium having computer-readable program instructions stored therein, the computer-readable program instructions comprising program instructions configured to cause an apparatus to perform a method comprising:
determining at least one desired media content to be captured;
causing information regarding a request to be transmitted to at least two media capturing devices to capture media content at distinct positions; and
receiving information regarding the captured media content captured by the media capturing devices.

14. The computer program product of claim 13, wherein the information regarding the request comprises augmented reality data.

15. The computer program product of claim 13, wherein the augmented reality data comprises an augmented reality map.

16. The computer program product of claim 13, wherein the augmented reality data comprises a targeting indicator configured to provide a user with an indication when the user has an appropriate view of a scene to be captured.

17. The computer program product of claim 13 further configured to cause an apparatus to perform a method comprising:
aligning the captured media contents along a unified timeline; and
compiling a composite media content comprising portions of the captured media contents.

18. The computer program product of claim 17 further configured to cause an apparatus to perform a method comprising selecting portions of any one of the captured media contents so as to create a composite media content including at least one of a multi-camera zoom portion and a multi-camera panning portion.
